(19) United States
(12) Patent Application Publication
(10) Pub. No.: US 2016/0004905 A1
(43) Pub. Date: Jan. 7, 2016

(54) METHOD AND SYSTEM FOR FACIAL EXPRESSION TRANSFER

(71) Applicants: Simon Lucey, Campbell (AU); Jason M. Saragih, Campbell (AU)

(72) Inventors: Simon Lucey, Campbell (AU); Jason M. Saragih, Campbell (AU)

(73) Assignee: Commonwealth Scientific and Industrial Research Organisation, Campbell (AU)

(21) Appl. No.: 13/700,210

(22) PCT Filed: Mar. 21, 2012
(86) PCT No.: PCT/AU12/00295

§ 371 Date: Aug. 27, 2015

(51) Int. Cl. G06K 9/00; H04N 7/15; G06K 9/62

(52) U.S. Cl. CPC G06K 9/00302; G06K 9/00228; G06K 9/627; H04N 7/157

(57) ABSTRACT

A method and system of expression transfer, and a video conferencing system to enable improved video communications. The method includes receiving, on a data interface, a source training image; generating, by a processor and using the source training image, a plurality of synthetic source expressions; generating, by the processor, a plurality of source-avatar mapping functions; receiving, on the data interface, an expression source image; and generating, by the processor, an expression transfer image based upon the expression source image and one or more of the plurality of source-avatar mapping functions. Each source-avatar mapping function maps a synthetic source expression to a corresponding expression of a plurality of avatar expressions. The plurality of mapping functions map each of the plurality of synthetic source expressions.

### FIELD OF THE INVENTION

The present invention relates to expression transfer. In particular, although not exclusively, the invention relates to facial expression transfer.

### BACKGROUND TO THE INVENTION

Non-verbal social cues play a crucial role in communicating emotion, regulating turn-taking, and achieving and sustaining rapport in conversation. As such, face-to-face conversation often is preferable to text-based exchanges. Until recently, real-time conversation over distance was limited to text or voice transmission. But with increased access to fast, reliable broadband, it has become possible to achieve audio-visual face-to-face communication through video-conferencing.

Video-conferencing has become an efficient means to achieve effective collaboration over long distances. However, several factors have limited the adoption of this technology. A critical one is lack of anonymity. Unlike text or voice systems, video immediately reveals a user's identity. Yet, in many applications it is desirable to preserve anonymity.

Attempts have been made to anonymize video conferencing systems by blurring the face, but this compromises the very advantages of video-conference technology, as it eliminates facial expression that communicates emotion and helps coordinate interpersonal behaviour.

An alternative to blurring video is to use avatars or virtual characters to relay non-verbal cues between conversation partners. In this way, emotive content and social signals in a conversation can be retained without compromising identity.

One approach to tackling this problem involves projecting a deformation field (i.e. the difference between features of a neutral and expressive face) of the user onto a subspace describing the expression variability of the avatar. This is achieved by learning a basis of variation for both the user and avatar from sets of images that represent the span of facial expressions for that person or avatar.

A disadvantage of this approach is that it requires knowledge of the expression variation of both the user and the avatar. The sets of images required to achieve this may not be readily available and/or may be difficult to collect.

An alternative approach to learning the basis variation of the user is to apply an automatic expression recognition system to detect the user's broad expression category and render the avatar with that expression.

A disadvantage of this approach is that realistic avatar animation is not possible, since detection and hence transfer is only possible at a coarse level including only broad expressions.

### OBJECT OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

### SUMMARY OF THE INVENTION

According to one aspect, the invention resides in a method of expression transfer, including:

receiving, on a data interface, a source training image;

generating, by a processor and using the source training image, a plurality of synthetic source expressions;

generating, by the processor, a plurality of source-avatar mapping functions, each source-avatar mapping function mapping a synthetic source expression to a corresponding expression of a plurality of avatar expressions, the plurality of mapping functions mapping each of the plurality of synthetic source expressions;

receiving, on the data interface, an expression source image; and

generating, by the processor, an expression transfer image based upon the expression source image and one or more of the plurality of source-avatar mapping functions.

Preferably, the synthetic source expressions include facial expressions. Alternatively or additionally, the synthetic source expressions include at least one of a sign language expression, a body shape, a body configuration, a hand shape and a finger configuration. According to certain embodiments, the plurality of avatar expressions include non-human expressions.

Preferably, the method further includes:

generating, by the processor and using an avatar training image, the plurality of avatar expressions, each avatar expression of the plurality of avatar expressions being a transformation of the avatar training image.

Preferably, generation of the plurality of avatar expressions comprises applying a generic shape mapping function to the avatar training image and generation of the plurality of synthetic source expressions comprises applying the generic shape mapping function to the source training image. The generic shape mapping functions are preferably generated using a training set of annotated images.

Preferably, the source-avatar mapping functions each include a generic component and a source-specific component.

Preferably, the method further includes generating a plurality of landmark locations for the expression source image, and applying the one or more source-avatar mapping functions to the plurality of landmark locations. A depth for each of the landmark locations is preferably generated.

Preferably, the method further includes applying a texture to the expression transfer image.

Preferably, the method further includes:

estimating, by the computer processor, a location of a pupil in the expression source image;

generating, by the computer processor, a synthetic eye in the expression transfer image according to the location of the pupil.

Preferably, the method further includes:

retrieving, by the computer processor and from the expression source image, image data relating to an oral cavity; and

transforming, by the computer processor, the image data relating to the oral cavity;

applying, by the computer processor, the transformed image data to the expression transfer image.

According to another aspect, the invention resides in a system for expression transfer, including:

a computer processor;

a data interface coupled to the processor;

a memory coupled to the computer processor, the memory including instructions executable by the processor for:
receiving, on the data interface, a source training image;
generating, using the source training image, a plurality of synthetic source expressions;
generating a plurality of source-avatar mapping functions, each source-avatar mapping function mapping an expression of the synthetic source expressions to a corresponding expression of a plurality of avatar expressions, the plurality of mapping functions mapping each of the synthetic source expressions;
receiving, on the data interface, a expression source image; and
generating an expression transfer image based upon the expression source image and one or more of the plurality of source-avatar mapping functions.

Preferably, the memory further includes instructions executable by the processor for:

generating, using an avatar training image, the plurality of avatar expressions, each avatar expression of the plurality of avatar expressions being a transformation of the avatar training image.

Preferably, generation of the plurality of avatar expressions and generation of the plurality of synthetic source expressions comprises applying a generic shape mapping function.

Preferably, the memory further includes instructions executable by the processor for:

generating a set of landmark locations for the expression source image; and

applying the one or more source-avatar mapping functions to the landmark locations.

Preferably, the memory further includes instructions executable by the processor for:

applying a texture to the expression transfer image.

Preferably, the memory further includes instructions executable by the processor for:

estimating a location of a pupil in the expression source image; and

generating a synthetic eye in the expression transfer image based at least partly on the location of the pupil.

Preferably, the memory further includes instructions executable by the processor for:

retrieving from the source image, image data relating to an oral cavity;

transforming the image data relating to the oral cavity; and

applying, by the computer processor, the transformed image data to the expression transfer image.

According to yet another aspect, the invention resides in a video conferencing system including:

a data reception interface for receiving a source training image and a plurality of expression source images, the plurality of expression source images corresponding to a source video sequence;

a source image generation module for generating, using the source training image, a plurality of synthetic source expressions;

a source-avatar mapping generation module for generating a plurality of source-avatar mapping functions, each source-avatar mapping function mapping an expression of an expression of the plurality of synthetic source expressions to a corresponding expression of a plurality of avatar expressions, the plurality of mapping functions mapping each expression of the plurality of synthetic source expressions;

an expression transfer module, for generating an expression transfer image based upon an expression source image and one or more of the plurality of source-avatar mapping functions; and

a data transmission interface, for transmitting a plurality of expression transfer images, each of the plurality of expression transfer images generated by the expression transfer module, the plurality of expression images corresponding to an expression transfer video.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1 illustrates a method of expression transfer, according to an embodiment of the present invention;

FIG. 2 illustrates two-dimensional and three dimensional representations of facial images, according to an embodiment of the present invention;

FIG. 3 illustrates a plurality of facial expressions according to an embodiment of the present invention;

FIG. 4 illustrates a video conferencing system according to an embodiment of the present invention.

FIG. 5 illustrates a video conferencing system according to an alternative embodiment of the present invention;

FIG. 6 diagrammatically illustrates a computing device, according to an embodiment of the present invention; and

FIG. 7 illustrates a video conferencing system according to an embodiment of the present invention.

Those skilled in the art will appreciate that minor deviations from the layout of components as illustrated in the drawings will not detract from the proper functioning of the disclosed embodiments of the present invention.

### DETAILED DESCRIPTION OF THE INVENTION

Embodiments of the present invention comprise expression transfer systems and methods. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

According to one aspect, the invention resides in a method of expression transfer, including: receiving, on a data interface, a source training image; generating, by a processor and using the source training image, a plurality of synthetic source expressions; generating, by the processor, a plurality of source-avatar mapping functions, each source-avatar mapping function mapping a synthetic source expression to a corresponding expression of a plurality of avatar expressions, the plurality of mapping functions mapping each of the plurality of synthetic source expressions; receiving, on the data interface, an expression source image; and generating, by the processor, an expression transfer image based upon the expression source image and one or more of the plurality of source-avatar mapping functions.

Advantages of certain embodiments of the present invention include that anonymity in an image or video is possible while retaining a broad range of expressions, it is possible to efficiently create images or video including artificial characters, such as cartoons or three-dimensional avatars including realistic expression, it is simple to add a new user or avatar to a system as only a single image is required and knowledge of the expression variation of the user or avatar is not required, and the systems and/or methods can efficiently generate expression transfer images in real time.

The embodiments below are described with reference to facial expression transfer, however the skilled addressee will understand that various types of expression, including non-facial expression, can be transferred and can adapt the embodiments accordingly. Examples of non-facial expressions include, but are not limited to, a sign language expression, a body shape, a body configuration, a hand shape and a finger configuration.

Additionally, the embodiments are described with reference to expression transfer from an image of a person to an image of an avatar. However, the skilled addressee will understand that the expression can be transferred between various types of images, including from one avatar image to another avatar image, and from an image of a person to an image of another person, and can adapt the described embodiments accordingly.

Similarly, the term avatar image encompasses any type of image data in which an expression can be transferred. The avatar can be based upon an artificial character, such as a cartoon character, or comprise an image of a real person. Further, the avatar can be based upon a non-human character, such as an animal, or a fantasy creature such as an alien.

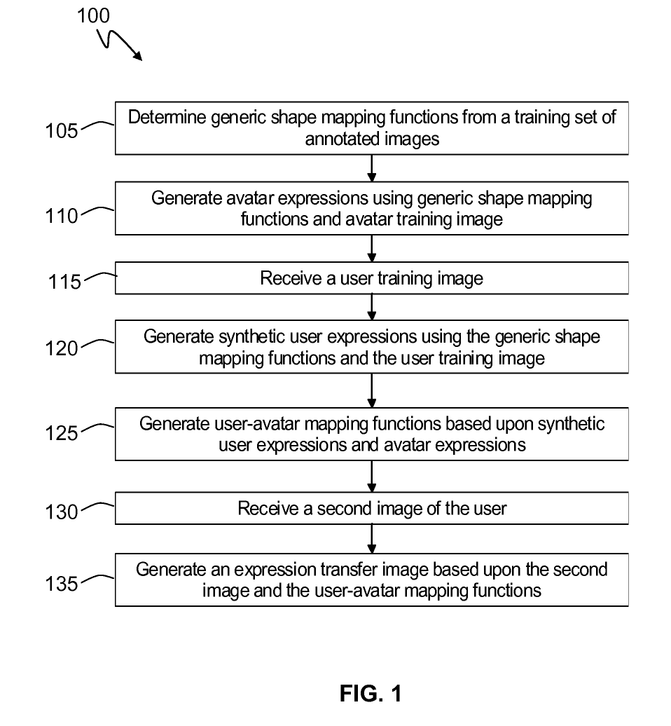

FIG. 1 illustrates a method 100 of expression transfer, according to an embodiment of the present invention.

In step 105, a plurality of generic shape mapping functions are determined from a training set of annotated images. Each generic shape mapping function corresponds to an expression of a predefined set of expressions, and defines a change in shape due to the expression. Examples of expressions include anger, fear, disgust, joy, sadness and surprise.

The generic shape mapping functions can be based upon MPEG-4 facial animation parameters, for example, which represent a set of basic facial actions, enabling the representation of a large number of facial expressions.

The mapping functions can be determined by minimising the prediction error over a large number of deformations described in training data. This is illustrated in equation 1, where X̅ᵢ is the neutral expression for the i^{th} subject in the training data, X ᵢ^{e} is the same subject with expression e, and Mₑ is the mapping function for expression e.

$${min}_{{ℳ}_{e}} {\sum }_{i = 1}^{N} {‖ {x}_{i}^{e} - {ℳ}_{e} ( {\overline{x}}_{i} ) ‖}^{2} \qquad ( 1 )$$

Examples of training data include Multi-PIE (IEEE International Conference on Automatic Face and Gesture Recognition, pages 1-8, 2008) and Karolinska directed emotional faces (KDEF) (Technical Report ISBN 91-630-7164-9, Department of Clinical Neuroscience, Psychology section, Karolinska Institute, 1998).

Both Multi-PIE and KDEF include annotated images of several basic emotions.

The annotation advantageously includes information that can be used to generate a 3D linear shape model. The generic shape mapping functions can then be determined according to points of the 3D linear shape model, such as points around eyes, mouth, nose and eyebrows, and also be defined as having a three-dimensional linear shape model as input.

According to an alternative embodiment, the generic shape mapping functions are pre-known, stored on a memory, or provided via a data interface.

In step 110, a plurality of avatar expressions are generated for the avatar and for the predefined set of expressions. Each avatar expression of the plurality of avatar expressions is generated by transforming an avatar training image using one of the generic shape mapping functions.

According to an embodiment, the avatar expression comprises a three-dimensional linear shape model, which is generated by transforming a three-dimensional linear shape model of the avatar training image.

The three-dimensional linear shape model includes points relating to objects of interest, such as eyes, mouth, nose and eyebrows. The three-dimensional linear shape model can be generated by allocating points to the avatar training image and assigning a depth to each point based upon training data.

According to an alternative embodiment, the avatar expressions are pre-known, stored on a memory, provided via an interface, or generated based upon other knowledge of the avatar.

Steps 105 and 110 are advantageously performed offline. Step 105 needs only to be performed once and can then be used with any number of users or avatars. Similarly, step 110 only needs to be performed once per avatar.

In step 115, a user training image is received. The user training image is advantageously an image containing a neutral expression of the user. The user training image can be received on a data interface, which can be a camera data interface, a network data interface, or any other suitable data interface.

In step 120, a plurality of synthetic user expressions are generated, based on the user training image, and for the discrete set of expressions. Each synthetic user expression of the plurality of synthetic user expressions is generated by transforming the user training image, or features thereof, using one of the generic mapping functions.

According to an embodiment, the user expression comprises a three-dimensional linear shape model, which is generated by transforming a three-dimensional linear shape model of the user training image, and can be generated in a similar way to the avatar expression discussed above.

As will be understood be a person skilled in the art, a 3D linear shape model can be represented in many ways, for example as a two dimensional image and a depth map.

In step 125 a user-avatar mapping is generated based on the user's synthetic expressions and corresponding expressions of the avatar. A plurality of user-avatar mapping functions is generated, one for each expression in the discrete set of expressions.

According to an embodiment, the user-avatar mapping is generated using the three-dimensional linear shape models of the user's synthetic expressions and corresponding expressions of the avatar. Similarly, the user-avatar mapping can be used to transform a three-dimensional linear shape model.

The user-avatar mapping functions advantageously includes a generic component and an avatar-user specific component. The generic component assumes that deformations between the user and the avatar have the same semantic meaning, whereas the avatar-user specific components are learnt from the user's synthetic expression images and corresponding expression images of the avatar.

By combining a generic component and an avatar-user specific component, it is possible to accurately map expressions close to one of the expressions in the discrete set of expressions, while being able to also map expressions that are far from these. More weight can be given to the avatar-user specific component when the discrete set of expressions includes a large number of expressions.

The user-avatar mapping can be generated, for example, using Equation 2, where R is the user-avatar mapping function, I is the identity matrix, E is the set of expressions in the database, α is between 0 and 1, and qₑ and pₑ are avatar expression images and synthetic user expression images, respectively, for expression e.

$${min}_{R} α {‖ R - I ‖}^{2} + ( 1 - α ) {\sum }_{e ∈ ɛ} {‖ {Rp}_{e} - {q}_{e} ‖}^{2} \qquad ( 2 )$$

The first term in Equation 2 is avatar-user specific, and gives weight to deformations between the user and the avatar having the same semantic meaning. This is specifically advantageous when little mapping data is available between the user and the avatar. As α→1, the user-avatar mapping approaches the identity mapping, which simply applies the deformation of the user directly onto the avatar.

The second term in Equation 2 is generic, and relates to semantic correspondence between the user and avatar as defined by the training data. As α→0, the user-avatar mapping is defined entirely by the training data.

The weights given to the first and second terms, α and 1-α, respectively, are advantageously based upon the amount and/or quality of the training data. By setting α to be a value between zero and one, one effectively learns a mapping that is both respectful of semantic correspondences as defined through the training set as well as exhibiting the capacity to mimic out-of-set expressions, albeit assuming direct mappings for these out-of-set expressions. The term α should accordingly be chosen based upon the number of expressions in the training set as well as their variability. Generally, α should be decreased as the number of training expressions increases, placing more emphasis on semantic correspondences as data becomes available.

One or more of steps 115, 120 and 125 can be performed during a registration phase, which can be separate to any expression transfer. For example, a user can register with a first application, and perform expression transfer with a separate application.

In step 130, a second image of the user is received on a data interface. The second image can, for example, be part of a video sequence.

In step 135, an expression transfer image is generated. The expression transfer image is generated based upon the second image and one or more of the user-avatar mapping functions. The expression transfer image thus includes expression from the second image and avatar image data.

The expression transfer can be background independent and include any desired background, including background provided in the second image, background associated with the avatar, an artificial background, or any other suitable image.

According to certain embodiments, the method 100 further includes texture mapping. Examples of texture include skin creases, such as the labial furrow in disgust, which are not represented by relatively sparse three dimensional shape models.

In a similar fashion to the generic shape mapping discussed above, a generic texture mapping can be used to model changes in texture due to expression.

The texture mapping is generated by minimising an error between textures of expression images, and textures of neutral images with a shaped dependent texture mapping applied.

According to some embodiments, the method 100 further includes gaze transfer. Since changes in gaze direction can embody emotional states, such as depression and nervousness, an avatar with gaze transfer appears more realistic than an avatar without gaze transfer.

A location of a pupil in the expression source image is estimated. The location is advantageously estimated relative to the eye, or the eyelids.

A pupil is synthesised in the expression transfer image within a region enclosed by the eyelids. The synthesized pupil is approximated by a circle, and the appearance of the circle is obtained from an avatar training image. If parts of the pupil are obscured by the eyelids, a circular symmetrical geometry of the eyelid is assumed and the obscured portion of the eyelid is generated. Finally, the avatar's eye colours are scaled according to the eyelid opening to mimic the effects of shading.

Other methods of gaze transfer also can be used. The inventors have, however, found that the above described gaze transfer technique captures coarse eye movements that are sufficient to convey non-verbal cues, with little processing overhead.

According to certain embodiments, the present invention includes oral cavity transfer. Rather than modelling an appearance of the oral cavity using the three dimensional shape model or otherwise, the user's oral cavity is copied and scaled to fit the avatar mouth. The scaling can comprise, for example, a piecewise affine warp.

By displaying the user's oral cavity, warped to fit to the avatar, large variations in teeth, gum and tongue are possible, at a very low processing cost.

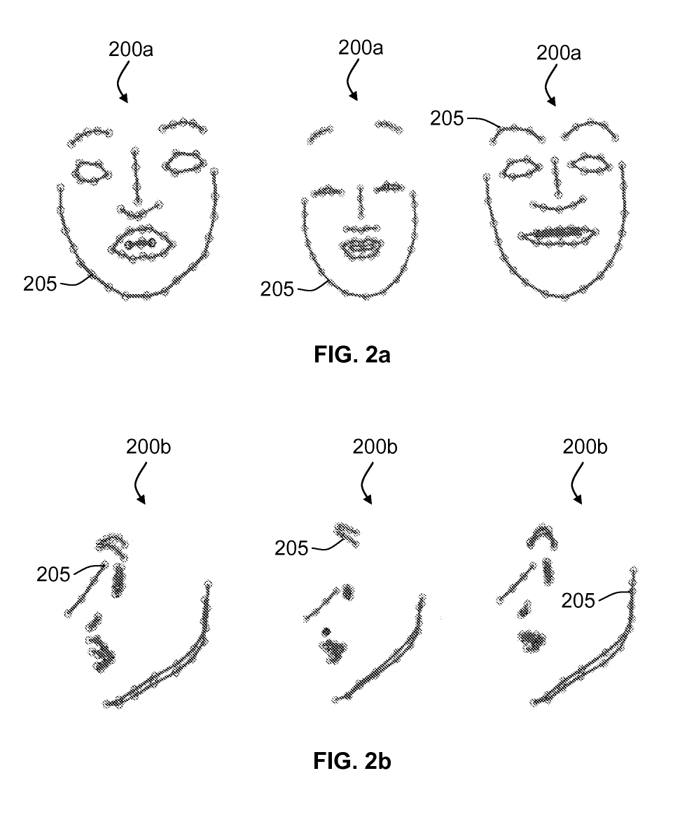

FIG. 2a illustrates two-dimensional representations 200a of facial images, and FIG. 2b illustrates profile views 200b of the two-dimensional representations 200a of FIG. 2a, wherein the profile views 200b have been generated according to a three-dimensional reconstruction.

The two-dimensional representations 200a include a plurality of landmark locations 205. The landmark locations 205 correspond to facial landmarks of a typical human face, and can include an eye outline, a mouth outline, a jaw outline, and/or any other suitable features. Similarly, non-facial expressions can be represented with different types of landmarks.

The landmark locations 205 can be detected using a facial alignment or detection algorithm, particularly if the face image is similar to a human facial image. Alternatively, manual annotation can be used to provide the landmark locations 205.

A three-dimensional reconstruction of the face is generated by applying a face shape model to the landmark locations 205, and assigning a depth to each of the landmark locations 205 based upon the model.

FIG. 2b illustrates profile views 200b, generated according to the depth of each landmark location 205.

The landmark locations 205, along with depth data, is advantageously used by the user-avatar mapping functions of FIG. 1.

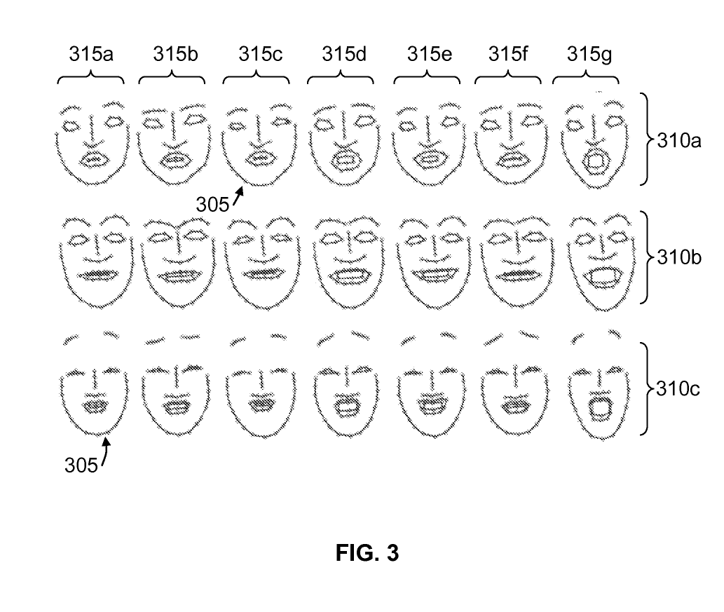

FIG. 3 illustrates a plurality of facial expression representations 305, according to an embodiment of the present invention.

The plurality of facial expression representations 305 include a first plurality of facial expression representations 310a, a second plurality of facial expression representations 310b and a third plurality of facial expression representations 310c, wherein each of the first, second and third pluralities correspond to a different user or avatar.

The plurality of facial expression representations 305 further includes a plurality of expressions 315a-g. Expression 315a corresponds to a neutral facial expression, expression 315b corresponds to an angry facial expression, expression 315c corresponds to disgust facial expression, expression 315d corresponds to a fear facial expression, expression 315e corresponds to a joy facial expression, expression 315f corresponds to a sad facial expression, and expression 315g corresponds to a surprise facial expression.

Each of the first, second and third pluralities of facial expression representations 310a, 310b, 310c include each of the plurality of expressions 315a-g, and can correspond, for example, to synthetic user expressions or avatar expressions as discussed above in the context of FIG. 1.

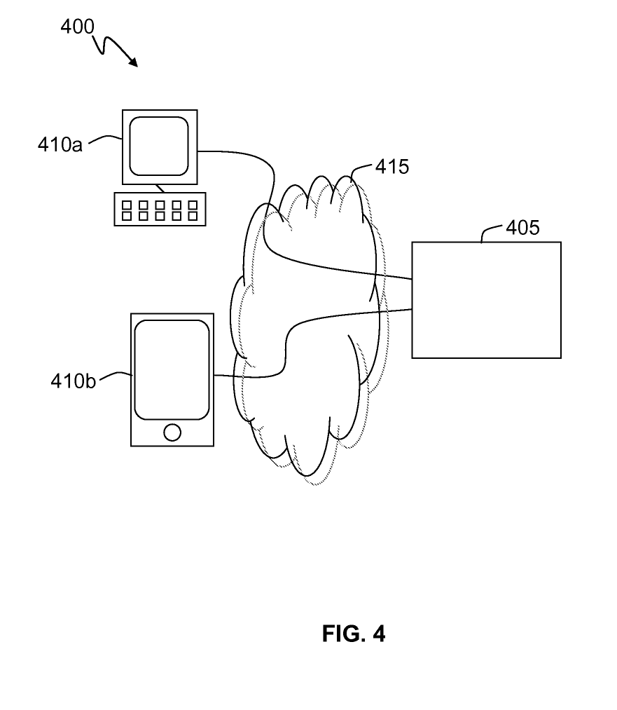

FIG. 4 illustrates a video conferencing system 400 according to an embodiment of the present invention.

The video conferencing system includes a gateway server 405 through which the video data is transmitted. The server 405 receives input video from a first user device 410a, and applies expression transfer to the input video before forwarding it to a second user device 410b as an output video. The input and output video is sent to and from the server 405 via a data network 415 such as the Internet.

Initially, the server 405 receives a source training image on a data reception interface. The source training image is then used to generate synthetic expressions and generate user-avatar mapping functions as discussed above with respect to FIG. 1.

The input video is then received from the first user device 410a, the input video including a plurality of expression source images. The output video is generated in real time based upon the expression source images and the source-avatar mapping functions, where the output video includes a plurality of expression transfer images.

The server 405 then transmits the output video to the second user device 410b.

As will be readily understood by the skilled addressee, the server 405 can perform additional functions such as decompression and compression of video in order to facilitate video transmission, or perform other functions.

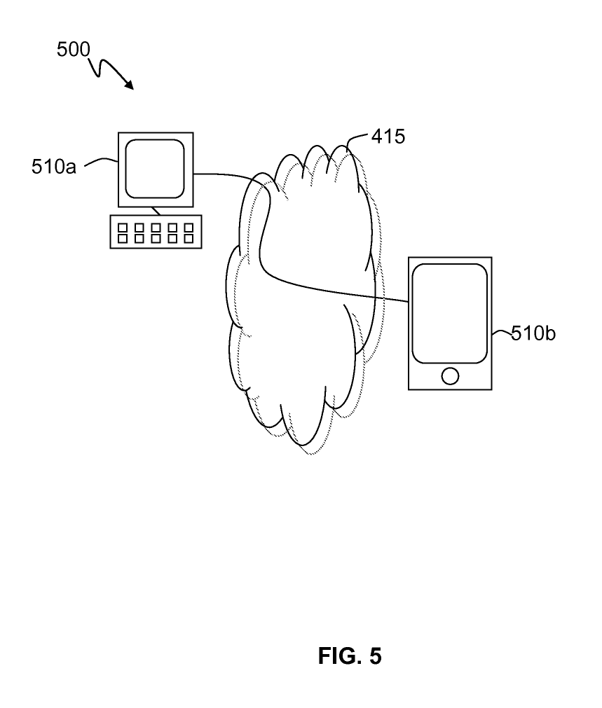

FIG. 5 illustrates a video conferencing system 500 according to an alternative embodiment of the present invention.

The video conferencing system includes a first user device 510a and a second user device 510b, between which video data is transmitted. The first user device 510a receives input video data from, for example, a camera and applies expression transfer to the input video before forwarding it to the second user device 510b as an output video. The output video is sent in real time to the second user device 510b via the data network 415.

The video conferencing system 500 is similar to video conferencing system 400 of FIG. 4, except that the expression transfer takes place on the first user device 510a rather than on the server 405.

The video conferencing system 400 or the video conferencing system 500 need not transmit video corresponding to the expression transfer video. Instead, the server 405 or the first user device 510a can transmit shape parameters which are then applied to the avatar using user-avatar mappings present on the second user device 410b, 510b. The user avatar mappings may similarly be transmitted to the second user devices 410b, 510b, or additionally learnt on the second user device 410b, 510b.

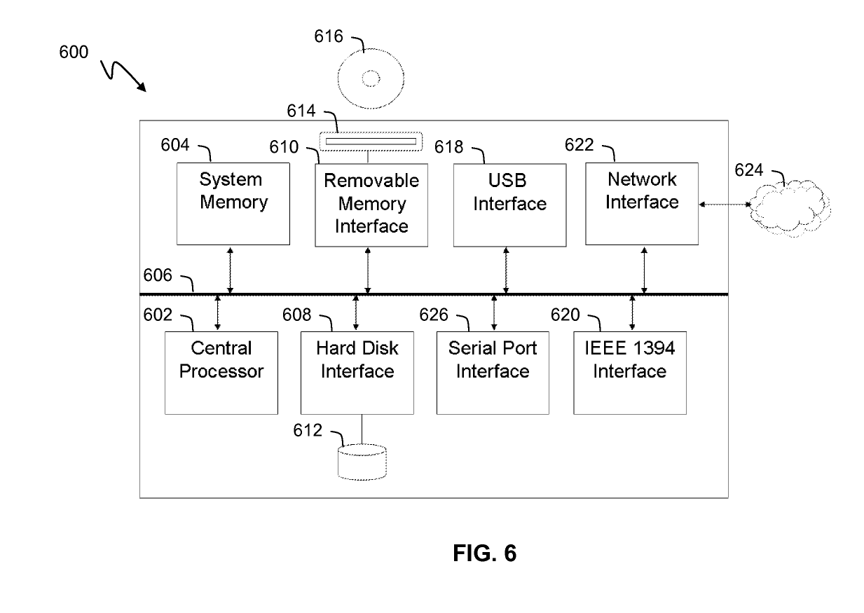

FIG. 6 diagrammatically illustrates a computing device 600, according to an embodiment of the present invention. The server 405 of FIG. 4, the first and second user devices 410a, 410b of FIG. 4 and the first and second user devices 510a, 510b of FIG. 5, can be identical to or similar to the computing device 600 of FIG. 6. Similarly, the method 100 of FIG. 1 can be implemented using the computing device 600.

The computing device 600 includes a central processor 602, a system memory 604 and a system bus 606 that couples various system components, including coupling the system memory 604 to the central processor 602. The system bus 606 may be any of several types of bus structures including a memory bus or memory controller, a peripheral bus, and a local bus using any of a variety of bus architectures. The structure of system memory 604 is well known to those skilled in the art and may include a basic input/output system (BIOS) stored in a read only memory (ROM) and one or more program modules such as operating systems, application programs and program data stored in random access memory (RAM).

The computing device 600 can also include a variety of interface units and drives for reading and writing data. The data can include, for example, the training data or the mapping functions described in FIG. 1, and/or computer readable instructions for performing the method 100 of FIG. 1.

In particular, the computing device 600 includes a hard disk interface 608 and a removable memory interface 610, respectively coupling a hard disk drive 612 and a removable memory drive 614 to the system bus 606. Examples of removable memory drives 614 include magnetic disk drives and optical disk drives. The drives and their associated computer-readable media, such as a Digital Versatile Disc (DVD) 616 provide non-volatile storage of computer readable instructions, data structures, program modules and other data for the computer system 600. A single hard disk drive 612 and a single removable memory drive 614 are shown for illustration purposes only and with the understanding that the computing device 600 can include several similar drives. Furthermore, the computing device 600 can include drives for interfacing with other types of computer readable media.

The computing device 600 may include additional interfaces for connecting devices to the system bus 606. FIG. 6 shows a universal serial bus (USB) interface 618 which may be used to couple a device to the system bus 606. For example, an IEEE 1394 interface 620 may be used to couple additional devices to the computing device 600. Examples of additional devices include cameras for receiving images or video, such as the training images of FIG. 1.

The computing device 600 can operate in a networked environment using logical connections to one or more remote computers or other devices, such as a server, a router, a network personal computer, a peer device or other common network node, a wireless telephone or wireless personal digital assistant. The computing device 600 includes a network interface 622 that couples the system bus 606 to a local area network (LAN) 624. Networking environments are commonplace in offices, enterprise-wide computer networks and home computer systems.

A wide area network (WAN), such as the Internet, can also be accessed by the computing device, for example via a modem unit connected to a serial port interface 626 or via the LAN 624.

Video conferencing can be performed using the LAN 624, the WAN, or a combination thereof.

It will be appreciated that the network connections shown and described are exemplary and other ways of establishing a communications link between computers can be used. The existence of any of various well-known protocols, such as TCP/IP, Frame Relay, Ethernet, FTP, HTTP and the like, is presumed, and the computing device can be operated in a client-server configuration to permit a user to retrieve data from, for example, a web-based server.

The operation of the computing device can be controlled by a variety of different program modules. Examples of program modules are routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PCs, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

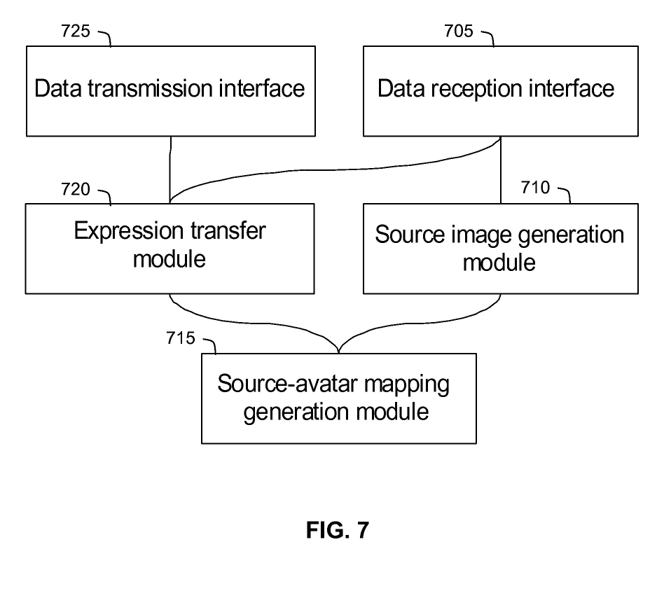

FIG. 7 illustrates a video conferencing system 700 according to an embodiment of the present invention.

The video conferencing system 700 includes a data reception interface 705, a source image generation module 710, a source-avatar mapping generation module 715, an expression transfer module 720, and a data transmission interface 725.

The data reception interface 705 can receive a source training image and a plurality of expression source images. The plurality of expression source images corresponds to a source video sequence which is to be processed.

The source image generation module 710 is coupled to the data reception interface 705, and is for generating a plurality of synthetic source expressions using the source training image.

The source-avatar mapping generation module 715 is for generating a plurality of source-avatar mapping functions, each source-avatar mapping function mapping an expression of the plurality of synthetic source expressions to a corresponding expression of a plurality of avatar expressions, the plurality of mapping functions mapping each expression of the plurality of synthetic source expressions.

The expression transfer module 720 is for generating an expression transfer image based upon an expression source image and one or more of the plurality of source-avatar mapping functions. The expression source images are received on the data reception interface 705.

Finally, the data transmission interface 725 is for transmitting a plurality of expression transfer images. Each of the plurality of expression transfer images is generated by the expression transfer module 720 and corresponds to an expression transfer video.

In summary, advantages of some embodiments of the present invention include that anonymity in an image or video is possible while retaining a broad range of expressions; it is possible to efficiently create images or video including artificial characters, such as cartoons or three-dimensional avatars, including realistic expression; it is simple to add a new user or avatar to a system as only a single image is required and knowledge of the expression variation of the user or avatar is not required; and the systems and/or methods can efficiently generate transfer images in real time.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

The claims defining the invention are:

1. A method of expression transfer, including:
receiving, on a data interface, a source training image;
generating, by a processor and using the source training image, a plurality of synthetic source expressions;
generating, by the processor, a plurality of source-avatar mapping functions, each source-avatar mapping function mapping a synthetic source expression to a corresponding expression of a plurality of avatar expressions, the plurality of mapping functions mapping each of the plurality of synthetic source expressions;
receiving, on the data interface, an expression source image; and
generating, by the processor, an expression transfer image based upon the expression source image and one or more of the plurality of source-avatar mapping functions.

2. A method according to claim 1, wherein the synthetic source expressions include facial expressions.

3. A method according to claim 1, wherein the synthetic source expressions include at least one of a sign language expression, a body shape, a body configuration, a hand shape and a finger configuration.

4. A method according to claim 1, wherein the plurality of avatar expressions include non-human expressions.

5. A method according to claim 1 further including:
generating, by the processor and using an avatar training image, the plurality of avatar expressions, each avatar expression of the plurality of avatar expressions being a transformation of the avatar training image.

6. A method according to claim 5, wherein generation of the plurality of avatar expressions comprises applying a generic shape mapping function to the avatar training image and generation of the plurality of synthetic source expressions comprises applying the generic shape mapping function to the source training image.

7. A method according to claim 6, wherein the generic shape mapping functions are generated using a training set of annotated images.

8. A method according to claim 1, wherein the source-avatar mapping functions each include a generic component and a source-specific component.

9. A method according to claim 1, further including:
generating a plurality of landmark locations for the expression source image, and applying the one or more source-avatar mapping functions to the plurality of landmark locations.

10. A method according to claim 1, further including generating a depth for each of the plurality of landmark locations.

11. A method according to claim 1, further including applying a texture to the expression transfer image.

12. A method according to claim 2, further including
estimating, by the computer processor, a location of a pupil in the expression source image;
generating, by the computer processor, a synthetic eye in the expression transfer image according to the location of the pupil.

13. A method according to claim 2, further including
retrieving, by the computer processor and from the expression source image, image data relating to an oral cavity; and
transforming, by the computer processor, the image data relating to the oral cavity;
applying, by the computer processor, the transformed image data to the expression transfer image.

14. A system for expression transfer, including:
a computer processor;
a data interface coupled to the processor;
a memory coupled to the computer processor, the memory including instructions executable by the processor for:
receiving, on the data interface, a source training image;
generating, using the source training image, a plurality of synthetic source expressions;
generating a plurality of source-avatar mapping functions, each source-avatar mapping function mapping an expression of the synthetic source expressions to a corresponding expression of a plurality of avatar expressions, the plurality of mapping functions mapping each of the synthetic source expressions;
receiving, on the data interface, a expression source image; and
generating an expression transfer image based upon the expression source image and one or more of the plurality of source-avatar mapping functions.

15. A system according to claim 14, wherein the memory further includes instructions executable by the processor for:
generating, using an avatar training image, the plurality of avatar expressions, each avatar expression of the plurality of avatar expressions being a transformation of the avatar training image.

16. A system according to claim 14, wherein generation of the plurality of avatar expressions and generation of the plurality of synthetic source expressions comprises applying a generic shape mapping function.

17. A system according to claim 14, wherein the memory further includes instructions executable by the processor for:
generating a set of landmark locations for the expression source image; and
applying the one or more source-avatar mapping functions to the landmark locations.

18. A system according to claim 14, wherein the memory further includes instructions executable by the processor for:
applying a texture to the expression transfer image.

19. A system according to claim 14, wherein the memory further includes instructions executable by the processor for:
estimating a location of a pupil in the expression source image; and
generating a synthetic eye in the expression transfer image based at least partly on the location of the pupil.

20. A system according to claim 14, wherein the memory further includes instructions executable by the processor for:
retrieving from the source image, image data relating to an oral cavity;
transforming the image data relating to the oral cavity; and
applying, by the computer processor, the transformed image data to the expression transfer image.

21. A video conferencing system including:
a data reception interface for receiving a source training image and a plurality of expression source images, the plurality of expression source images corresponding to a source video sequence;
a source image generation module for generating, using the source training image, a plurality of synthetic source expressions;
a source-avatar mapping generation module for generating a plurality of source-avatar mapping functions, each source-avatar mapping function mapping an expression of an expression of the plurality of synthetic source expressions to a corresponding expression of a plurality of avatar expressions, the plurality of mapping functions mapping each expression of the plurality of synthetic source expressions;
an expression transfer module, for generating an expression transfer image based upon an expression source image and one or more of the plurality of source-avatar mapping functions; and
a data transmission interface, for transmitting a plurality of expression transfer images, each of the plurality of expression transfer images generated by the expression transfer module, the plurality of expression images corresponding to an expression transfer video.
